(19) United States
(12) Patent Application Publication
(10) Pub. No.: US 2004/0070388 A1
(43) Pub. Date: Apr. 15, 2004

(54) Detecting rotational direction of a rotating article

(76) Inventors: Thomas Hong Chuang, Oklahoma City, OK (US); Stephen Gregory Horning, Oklahoma City, OK (US)

Correspondence Address: Mitchell McCarthy, Seagate Technology LLC, OKM270, 10321 West Reno, Oklahoma City, OK, 73127-7140, US

(21) Appl. No.: 10/461,273

(22) Filed: Jun. 13, 2003

Related U.S. Application Data
(60) Provisional application No. 60/417,353, filed on Oct. 9, 2002.

(51) Int. Cl. G01P 13/00

(52) U.S. Cl. 324/165; 73/460; 324/212; 310/68 B

(57) ABSTRACT

Method and apparatus for determining the rotational direction of a rotatable article, such as a spindle motor used in a data storage device to rotate a data recording disc. The article includes an index mark which is detected by an index sensor to identify an index reference position on the article. The index sensor and index mark are further used to detect the direction of rotation of the article. In some embodiments, a second sensor is provided so that first and second timing pulses are generated from the index mark by the index sensor and the second sensor. In other embodiments, a second (detection) mark is added to the article so that first and second timing pulses are generated by the index sensor. In either case, a rotational direction detection circuit determines the rotational direction of the article in relation to the first and second timing pulses.

### RELATED APPLICATIONS

This application claims priority under 35 U.S.C. §119(e) to U.S. Provisional Application No. 60/417,353 filed Oct. 9, 2002.

### FIELD OF THE INVENTION

This invention relates generally to the field of rotatable articles and more particularly, but not by way of limitation, to a method and apparatus for detecting a direction of rotation of an article such as a spindle motor used to rotate a data recording disc in a data storage device.

### BACKGROUND

It is often advantageous to affirmatively detect a direction of rotation of a rotatable article, such as an electrical motor, a shaft, a wheel, etc. to ensure the article is in fact rotating in the intended direction. For example, balancing systems are often used to measure an amount of imbalance in a rotatable article. When the imbalance is found to be sufficiently severe, a balance correction member can be attached to the article to correct the imbalance.

It can be readily appreciated that a successful balancing operation is predicated upon the article correctly rotating in the intended direction. Inadvertent rotation of the article in the opposite direction during a balancing operation will result in an accurate measurement of the magnitude of imbalance, but the indicated angle of imbalance will be incorrect. Thus, the balance correction member may be installed in the wrong location, potentially leading to a net increase in the imbalance in the article.

Unless the balancing process is configured to immediately repeat the balancing measurement after the balance correction member has been attached, the facts that the article remains imbalanced may escape notice. This has been found especially true in high volume manufacturing operations wherein spindle motors used to rotate data storage media (such as magnetic recording discs) have been improperly balanced due to reverse rotation of the spindle motors during balancing. In such cases the condition has not been detected until later in the assembly process, or after the devices have been shipped.

While various approaches to detecting rotational direction have been found operable, there nevertheless remains a continued need for improvements that carry out such detection in an efficient and effective manner. It is to such improvements that the present invention is directed.

### SUMMARY OF THE INVENTION

As embodied herein and as claimed below, the present invention is generally directed to a method and apparatus for determining the rotational direction of a rotatable article.

In accordance with preferred embodiments, an improved balancing system is provided to measure an amount of imbalance in a rotatable article (such as a spindle motor). The balancing system includes an energizing circuit which applies power to rotate the article, an index sensor which detects an index mark on the rotatable article, and a rotational imbalance detection circuit which identifies an appropriate radial position for the attachment of a balance correction member in relation to the index mark.

The balancing system further operates to use the index mark and the index sensor to detect a direction of angular rotation of the article.

In some preferred embodiments, the balancing system includes a second sensor positioned adjacent the article at a position a selected circumferential distance from the index sensor other than 180 degrees. A rotational direction detection circuit determines the direction of rotation of the article in response to first and second timing pulses generated by the index sensor and the second sensor as the timing mark passes adjacent the respective sensors.

In other preferred embodiments, the balancing system includes a second (detection) mark on the article a selected circumferential distance from the index mark other than 180 degrees. A rotational direction detection circuit determines the direction of rotation of the article in response to first and second timing pulses generated as the index mark and the detection mark pass adjacent the index sensor.

Detection of the rotation of the article ensures that the imbalance measurements obtained by the balancing system correctly reflect the actual imbalance (magnitude and angle) in the article, and enables the balance correction member to be placed in the correct location to remove the imbalance. Moreover, use of the existing index mark and index sensor provides a cost effective and efficient way to detect the rotational direction of the article.

These and various other features and advantages that characterize the claimed invention will be apparent upon reading the following detailed description and upon review of the associated drawings.

### BRIEF DESCRIPTION OF THE DRAWINGS

FIG. 1 is a top plan view of a data storage device constructed and operated in accordance with preferred embodiments of the present invention.

FIG. 2 is a functional block diagram of a balancing system configured to measure an amount of imbalance in the spindle motor of FIG. 1, as well as to confirm that the spindle motor is rotating in the desired direction during such imbalance measurement.

FIG. 3 illustrates a portion of the balancing system of FIG. 2 in greater detail to show the use of an additional (second) sensor to detect an index mark on the spindle motor in accordance with preferred embodiments.

FIG. 4 provides a top plan view of a portion of the spindle motor along with reading areas projected thereupon by the sensors of FIG. 3.

FIG. 5 is a timing diagram to represent the generation of first and second timing pulses generated by the sensors of FIG. 3 during rotation of the spindle motor.

FIG. 6 is a block diagram representation of the rotational direction detection circuit of FIG. 2 in accordance with the configuration of FIG. 3.

FIG. 7 illustrates a portion of the balancing system of FIG. 2 in greater detail to show the use of the index sensor of FIG. 2 in conjunction with a second (detection) mark on the spindle motor in accordance with alternative preferred embodiments.

FIG. 8 provides a top plan view of a portion of the spindle motor to show the index mark and the detection mark of FIG. 7.

FIG. 9 is a timing diagram to represent the generation of first and second timing pulses from the respective index and detection marks.

FIG. 10 is a block diagram representation of the rotational direction detection circuit of FIG. 2 in accordance with the configuration of FIG. 7.

FIG. 11 provides a top plan view of a portion of the spindle motor to show the use of a detection mark having a different size as compared to the index mark.

FIG. 12 is a timing diagram to show the generation of first and second timing pulses from the index and detection marks of FIG. 11.

FIG. 13 is a flow chart for a ROTATIONAL DIRECTION DETECTION routine illustrative of steps carried out in accordance with preferred embodiments of the present invention to detect the rotational direction of a rotating article.

### DETAILED DESCRIPTION

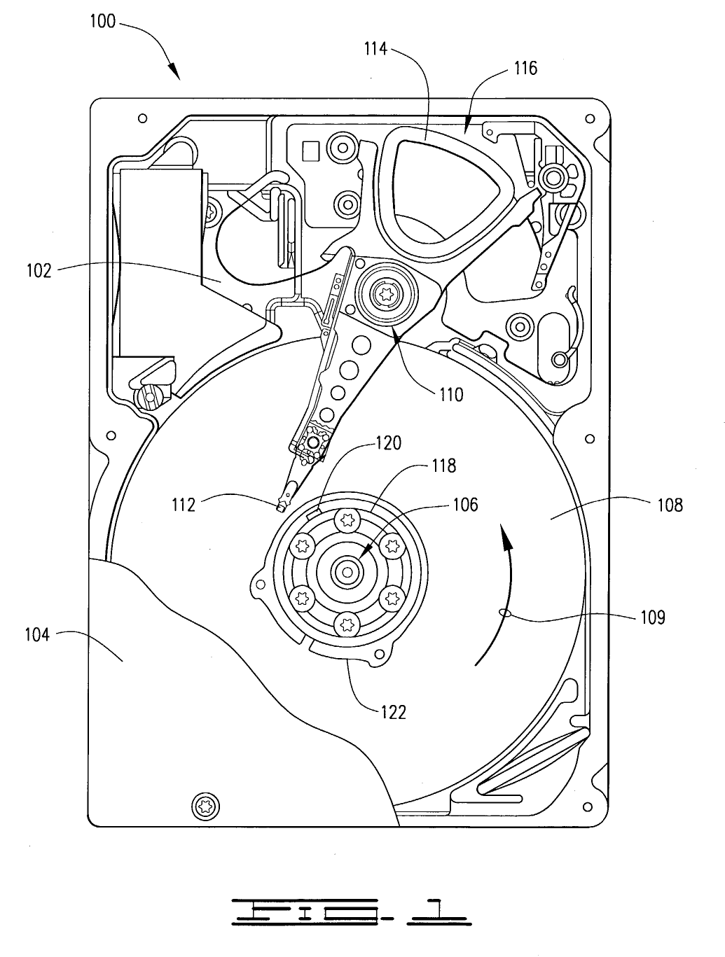

To provide an illustrative environment in which various preferred embodiments of the present invention can be advantageously practiced, FIG. 1 provides a top plan view of a data storage device 100 of the type used to store digital data. The data storage device 100 includes a rigid base deck 102 which cooperates with a top cover 104 (shown in partial cutaway) to form a sealed housing.

A spindle motor 106 is mounted within the housing to rotate one or more data storage discs 108 at a constant high speed in rotational direction 109. A rotary actuator assembly 110 supports a corresponding array of data transducing heads 112 used to write data to and read data from tracks defined on the disc surfaces. The heads 112 are moved across the disc surfaces by the controlled application of current to a coil 114 of a voice coil motor (VCM) 116.

A disc clamp 118 is used to clamp the disc(s) 108 to an outer hub of the spindle motor 106. The disc clamp 118 is provided with an index mark 120, preferably comprising a notch formed in an annular ridge of the clamp 118 as shown. A balance correction member 122 is affixed to the clamp, and preferably comprises an eccentric, c-shaped spring member. The size (mass) and the angular orientation of the member 122 are selected to correct measured imbalance in the spindle motor 106.

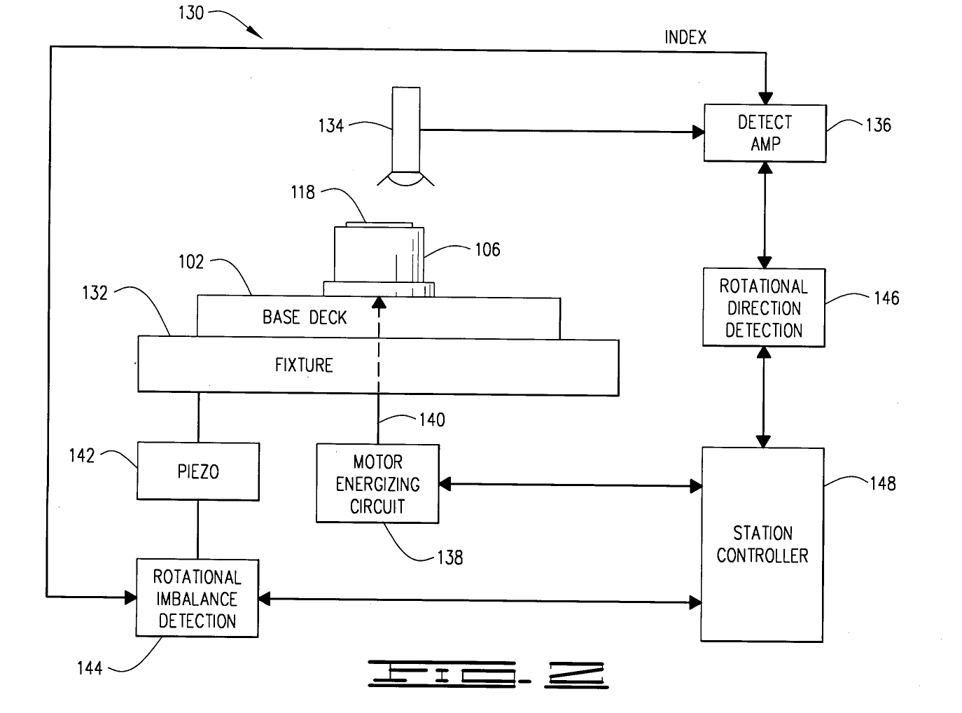

FIG. 2 provides a functional block diagram of a balancing system 130 configured to measure the imbalance in the spindle motor 106 of FIG. 1. It will be understood that the balancing system 130 operates during a manufacturing process in which the data storage device 100 is assembled.

The spindle motor 106 and base deck 102 are supported by a fixture 132. An index sensor 134, preferably comprising an optical transducer, is configured to emit a focused beam of light upon the disc clamp 118 and to detect passage of the index mark 120 in relation to a change in reflectivity in the light reflected from the clamp. A detection amplifier 136 coupled to the index sensor 134 conditions the output from the sensor 134 as a frequency modulated pulse stream. A particularly suitable index sensor and detection amplifier combination is commercially available as Model FS-V1 from Keyence Corporation, Woodcliff Lake, N.J., USA.

A motor energizing circuit 138 applies power to rotate the spindle motor 106 at a selected velocity. Preferably, the motor energizing circuit 138 uses a cable assembly (denoted by arrow 140) to engage coil terminals of the spindle motor 106. The spindle motor 106 preferably comprises a multi-phase direct current (dc) inductive motor, and the circuit 138 electrically commutates the motor 106 to rotate the motor hub at the desired velocity. It will be understood that when the article is not self-rotatable (e.g., a shaft, a disc, a tire, etc. instead of a motor), the energizing circuit 138 will further include a motor or other suitable mechanism to rotate the article at the desired velocity.

A piezo transducing assembly 142 senses vibrations induced in the fixture 132 along various orthogonal axes during rotation of the spindle motor 106, and provides corresponding amplitude modulated voltage signals to a rotational imbalance detection circuit 144. The rotational imbalance detection circuit 144 uses the input signals to calculate an amount of imbalance in the motor 106 in terms of magnitude and angle. The angle is determined with respect to the index mark 120 by way of an index signal supplied by the detection amplifier 136.

The detection amplifier 136 further provides a pulse stream generated by the index mark 120 and the index sensor 134 to a rotational direction detection circuit 146. The rotational direction detection circuit 146 operates to detect the direction of rotation of the spindle motor 106 based on the pulse stream from the detection amplifier 136, and indicates the direction of rotation to a station controller 148 via a direction signal. The station controller 148 provides top level control of the system 130, including initialization of the imbalance measurement by the imbalance detection circuit 144 once the motor 106 is determined to be rotating in the correct, intended direction.

It is contemplated that the system 130 is part of an automated assembly process wherein large numbers of base deck/spindle motor combinations are successively conveyed in turn to the system 130. Each base deck/spindle motor combination is then shuttled to an adjacent balance correction station (not shown) wherein an appropriate balance correction member (such as the member 122 shown in FIG. 1) is affixed to the spindle motor 106. The balance correction station selects and orients each balance correction member in response to the calculated imbalance from the system 130, and locates the balance correction member in relation to the index reference position provided by the index mark 120.

It will be apparent that proper operation of the system 130 depends on the spindle motor 106 rotating in the intended rotational direction. However, from time to time events can arise that inadvertently cause the spindle motor 106 to rotate in the opposite direction.

For example, the cable assembly 140 used to make electrical contact with the spindle motor 106 is routinely serviced to address wear and damage to contact pins used to establish electrical contact with the motor. If a replacement cable assembly is installed incorrectly, the energizing circuit 138 can successfully accelerate the motor to the desired velocity, but in the wrong direction.

Accordingly, various preferred embodiments of the present invention further utilize the index sensor 134 and the index mark 120 to identify the direction of rotation of the spindle motor prior to the imbalance measurement. One such embodiment utilizes a second sensor 150 that is incorporated into the system 130, as shown in FIG. 3. The second sensor 150 is nominally identical to the index sensor 134 and is likewise provided with a detection amplifier (such as 136 in FIG. 3) to output a frequency modulated pulse stream in relation to the detection of the index mark 120.

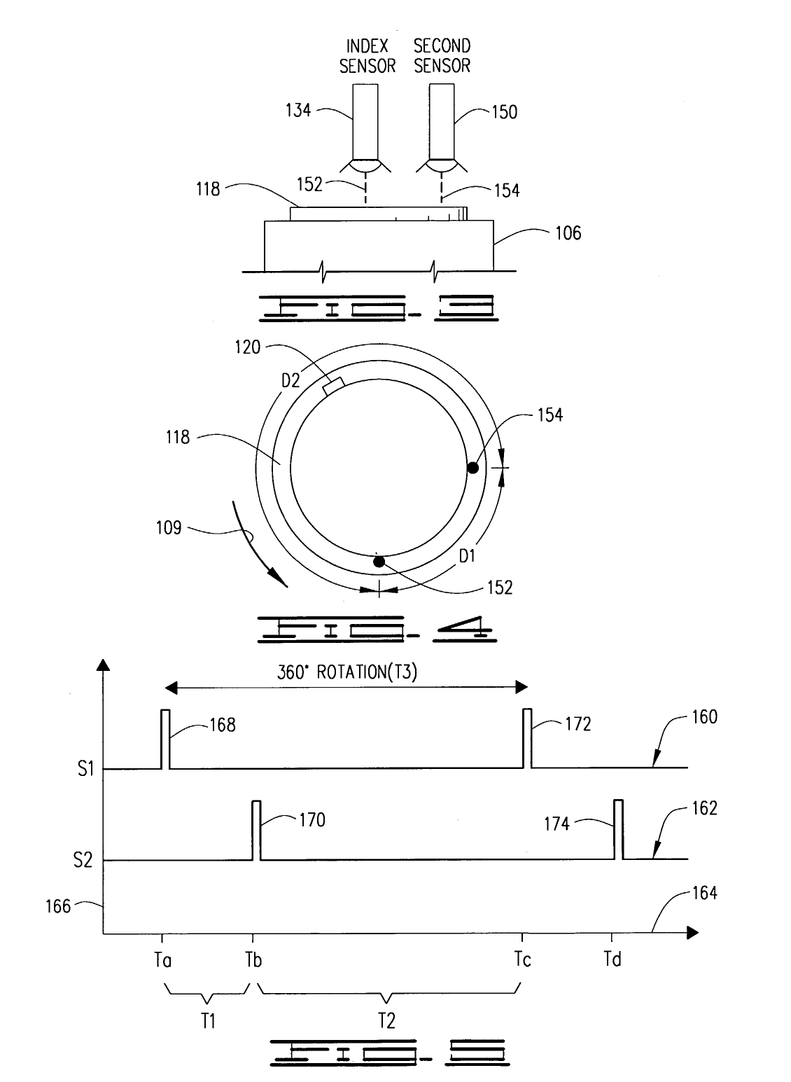

As best shown in FIG. 4, the sensors 134, 150 project respective beams 152, 154 upon the clamp 118. As the clamp 118 rotates (in intended direction 109), the index mark 120 will pass beneath the respective beams. The second sensor 150 is positioned adjacent the clamp 118 a selected circumferential distance from the index sensor 134 other than 180 degrees, so that a first circumferential distance between the index sensor 134 and the second sensor 150 (distance D1) is less than a second circumferential distance between the index sensor 134 and the second sensor 150 (distance D2). Although the distance D1 is shown to be less than D2, it will be readily apparent that the sensors 134, 150 can be moved so that D2 is less than D1.

FIG. 5 graphically illustrates respective S1 and S2 pulse streams 160, 162 generated by the index sensor 134 and the second sensor 150 during rotation of the clamp 118 in direction 109. The S1 and S2 pulse streams 160, 162 are plotted against an elapsed time x-axis 164 and a common amplitude y-axis 166.

A first timing pulse 168 is output at time Ta in the S1 stream 160 as the index mark 120 passes adjacent the index sensor 134, and a second pulse 170 is output at time Tb in the S2 stream 162 as the index mark 120 passes adjacent the second sensor 150. The elapsed time (Ti) between the first and second pulses 168, 170 corresponds to the time required for the clamp 118 to rotate through the distance D1.

A third pulse 172 in the S1 stream arises after a full 360 degrees of rotation at time Tc, and a fourth pulse 174 shortly occurs thereafter in the S2 stream at time Td. The elapsed time T2 between the second and third pulses 170, 172 corresponds to the time required for the clamp to rotate through the distance D2. It will be noted that the pulses 168 and 172 in the S1 stream 160 serve as index (once-around) pulses, and the rate at which the pulses 168, 172 are received can be used as an indicator of the velocity of the motor 106. The period of revolution as indicated by the successively received index marks is identified as time T3, which is nominally equal to T1+T2.

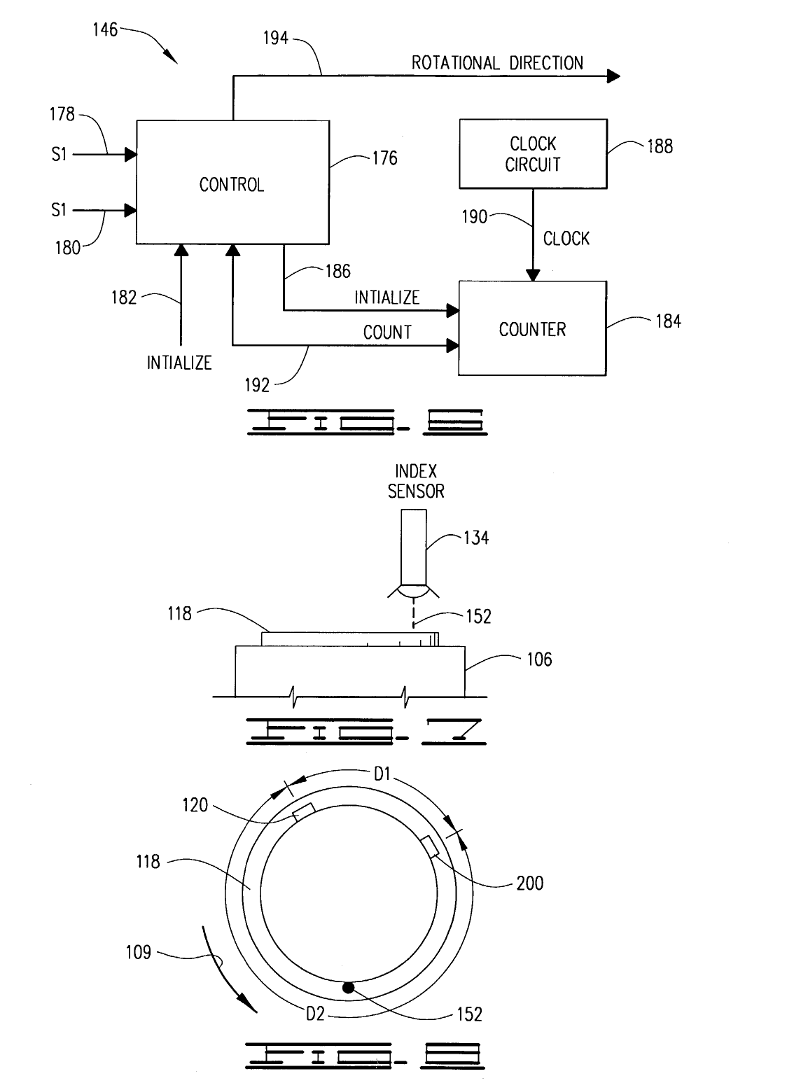

FIG. 6 illustrates relevant portions of the rotational direction detection circuit 146 of FIG. 2 in accordance with the embodiments of FIGS. 3 and 4. The S1 and S2 pulse streams 160, 162 are provided to a control block 176 via paths 178, 180 from the respective detection amps (136, FIG. 2). The control block 176 can be hardware or firmware (processor) based.

Upon receipt of an INITIALIZE signal on path 182 from the station controller 148 (FIG. 2), the control block waits for the next index pulse from the S1 path 178. Upon occurrence of the leading edge of the next index pulse (contemplated in this example as the pulse 168 in FIG. 5), the control block 176 initiates a counter 184 via INITIALIZE path 186. The counter 184 uses a relatively high frequency clock signal generated by a clock circuit 188 and provided via CLOCK path 190. The accumulated counts from the counter 184 are made available to the control block 176 via COUNT path 192.

Upon receipt of the second timing pulse 170 from the S2 path 180, the control block latches and temporarily stores the accumulated count value from the counter 184. The accumulated count value indicates the duration of the time T1, and can be used to determine the direction of rotation in a number of alternate ways that will now be discussed.

In one preferred approach, the value of time T1 is compared to the period of revolution T3 (i.e., the nominal time between index pulses 168, 172 in the S1 stream 160). The time T3 can be directly measured or simply assumed based on an indication by the energizing circuit 138 that the motor 106 is successfully commutating at the intended speed (e.g., 3500 revolutions per minute). In the present example, the sensors 134, 150 are nominally about 90 degrees apart (with the sensor 150 lagging the sensor 134), so that the time T1 represents about ¼ of the total period T3. Thus, the control block can readily determine that the motor 106 is running in the correct direction if time T1 is less than (T3)/2.

In another preferred approach, after obtaining an indication of the accumulated count value associated with the time T1, the control block 176 obtains a second accumulated count value indicative of the period of time T2 (using the counter 184 or a second counter not shown in FIG. 6). In this approach, the control block 176 readily determines that the motor 106 is running in the correct direction if time T2 is found to be greater than time T1.

As desired, the direction tests can be performed multiple times over successive rotations to ensure that noise or other factors have not adversely affected the results. Once the control block 176 has determined the direction of rotation, an indication is made via ROTATIONAL DIRECTION path 194 to the station controller 148.

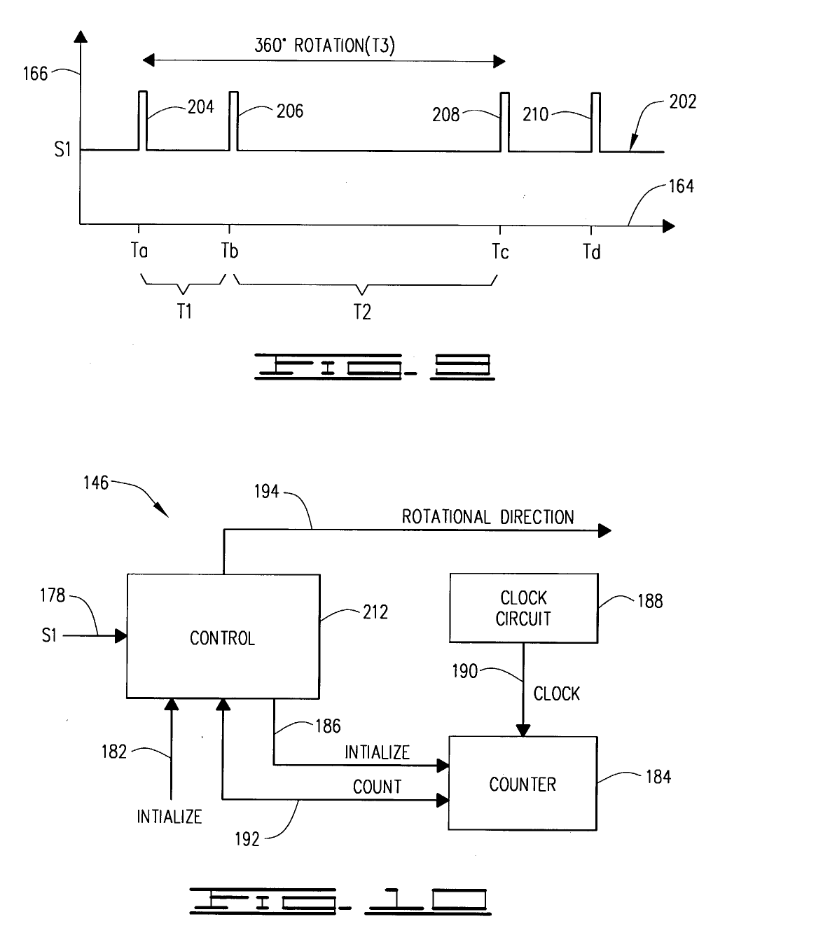

In various alternative preferred embodiments, the index sensor 134 and the index mark 120 are used to identify the direction of rotation of the spindle motor prior to the imbalance measurement as shown by FIGS. 7 and 8. That is, a single sensor (index sensor 134) is used in conjunction with an additional mark 200 on the disc clamp 118. The additional mark 200, also referred to herein as a detection mark, is substantially the same size as the index mark 120. The detection mark 200 is located at a distance other than 180 degrees from the index mark 120, so that different respective distances D1 and D2 are defined such as shown in FIG. 8.

This results in an S1 pulse stream 202 as shown in FIG. 9. First and third timing pulses 204, 208 arise from passage of the index mark 120 adjacent the index sensor 134, and second and fourth timing pulses 206, 210 arise from passage of the detection mark 200 adjacent the sensor 134. As before, the time between the first and second pulses 204, 206 is denoted as Ti, the time between the second and third pulses 204, 208 is denoted as T2, and the period of revolution (time between index pulses 204, 208) is time T3.

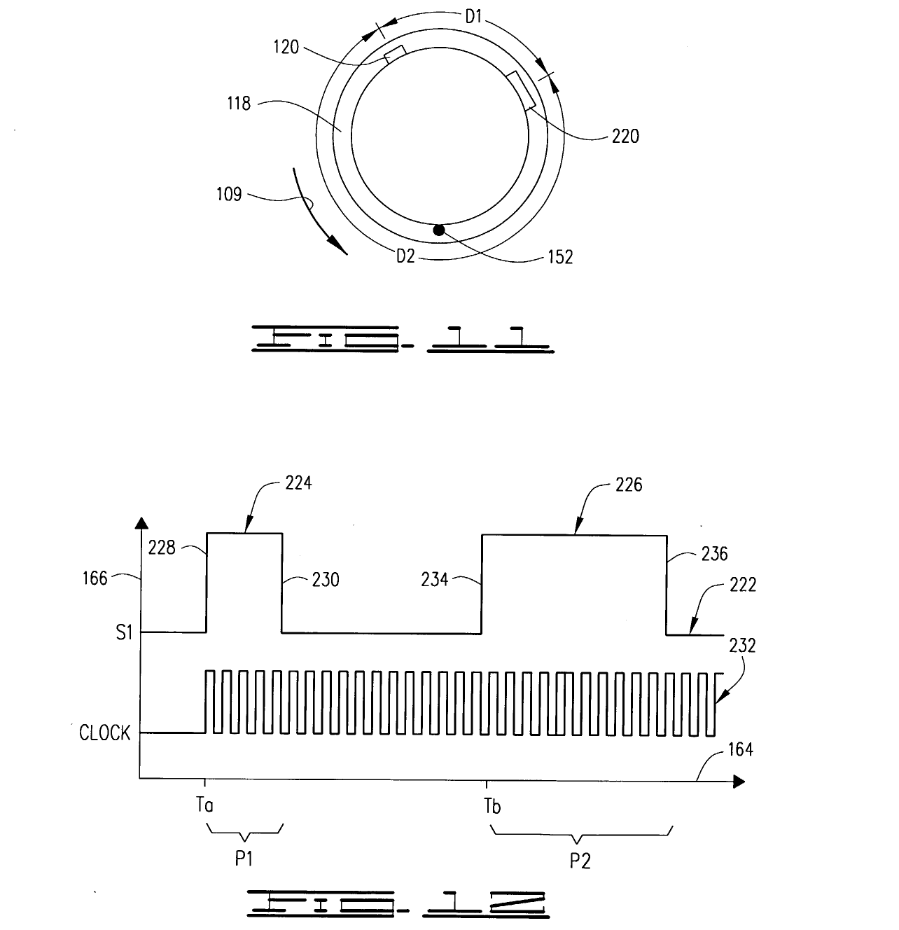

FIG. 10 shows the rotational direction detection circuit 146 in accordance with the embodiments of FIGS. 7-9. The circuit in FIG. 10 operates substantially as the circuit of FIG. 6, and like reference numerals are provided for similar components. One difference between the respective circuits of FIGS. 6 and 10 a control block 212 in FIG. 10, which is configured to receive all of the timing pulses 204, 206, 208 and 210 from the same S1 input path 178.

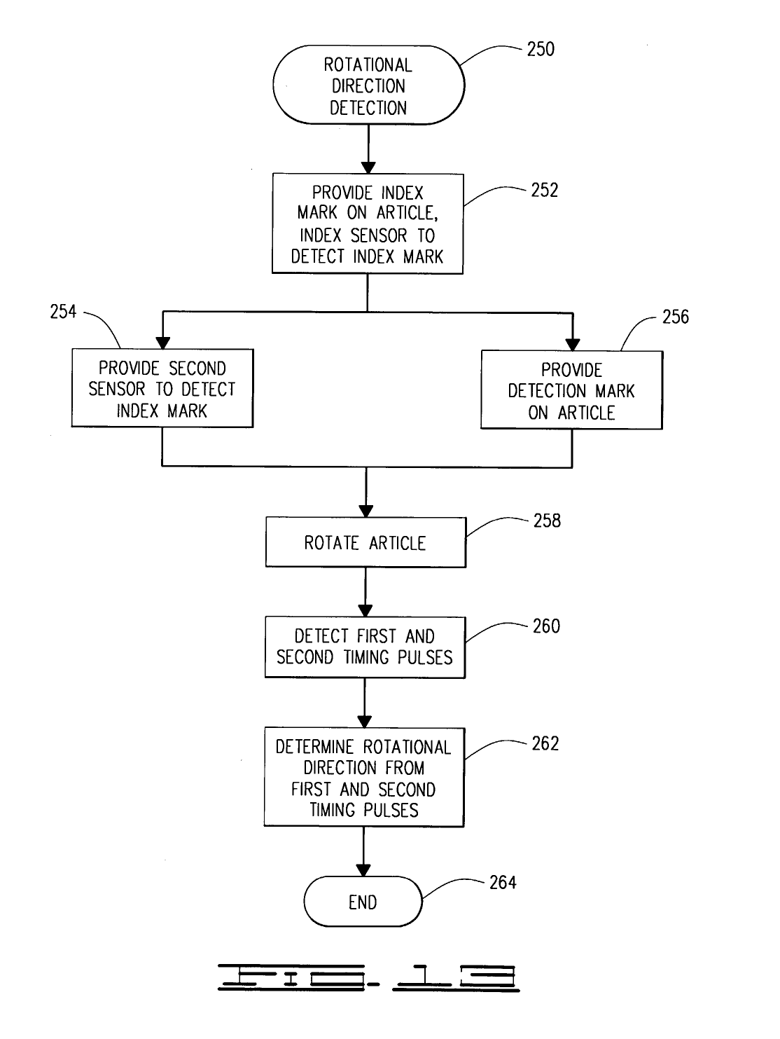

FIG. 11 shows another embodiment of the disc clamp 118 that is similar to that of FIG. 8, except that a detection mark 220 is provided with a length that is different than that of the index mark 120. This results in an S1 pulse stream 222 in FIG. 12 with a first timing pulse 224 from the index mark 120, and a second timing pulse 226 from the detection mark 220. Although the detection mark 220 is shown to be longer than the index mark 120, a shorter detection mark could be used as well.

An advantage of using different sized index and timing marks is the enhanced ability for equipment, such as video camera based detection systems, to readily differentiate between the index mark 120 and the detection mark 220 in order to properly locate the index position (index mark 120) for processing, such as during the installation of the balance correction member 122. Thus, the rotational direction detection circuit 146 of FIG. 10 can be readily configured to operate using the different sized marks 120, 220 in a manner similar to that described with respect to FIGS. 7-9. That is, since the circuit preferably operates by detection of the leading edges of the timing pulses, the relative lengths of the pulses will have no effect on the operation of the circuit.

Alternatively, the rotational direction detection circuit 146 of FIG. 10 can be configured to detect the respective durations (lengths) of the first and second timing pulses 224, 226 in making the rotational direction determination. In these embodiments, the control circuit 212 is configured to initiate the counter 184 upon receipt of a leading edge 228 of the first timing pulse 224 and to complete the count upon receipt of a trailing edge 230 of the first timing pulse. A sufficiently high frequency clock signal such as represented at 232 would be required, relative to the duration of the timing pulse 224 (the signal 232 is representative of the signal on path 190 in FIG. 10). This pulse width value of the first timing pulse 224 is denoted as P1.

The control block 212 next accumulates a second count between receipt of leading and trailing edges 234, 236 of the second timing pulse 226 to arrive at a second pulse width value P2. The control circuit 212 then compares the relative magnitudes of P1 and P2, and determines that the motor is rotating in the correct direction when P2>P1. As desired, time durations T1 and T2 can also be measured and processed as discussed above to further increase confidence in the resulting direction determination.

FIG. 13 provides a ROTATIONAL DIRECTION DETECTION routine 250 to summarize various steps discussed above in accordance with preferred embodiments to detect the rotational direction of an article such as the spindle motor 106 of FIG. 1.

At step 252, an index mark (such as 120) is provided on the article and an index sensor (such as 134) is provided to detect the index mark during rotation. Next, alternative steps are carried out; either a second sensor (such as 150) is provided to further detect the index mark, as indicated by step 254, or a second (detection) mark is placed on the article for further detection by the index sensor, step 256.

The article is next rotated at step 258, and first and second timing pulses (such as 168 and 170, 204 and 206, and 224 and 226) are detected at step 260. The rotational direction of the article is determined from the first and second timing pulses at step 262 as discussed above, including measurement of the elapsed time between the first and second pulses and measurement of the respective pulse durations of the first and second pulses. The process then ends at step 264.

It will be appreciated that the various preferred embodiments disclosed herein provide a cost effective and efficient way to detect the rotational direction of the article using the existing timing mark and timing sensor.

In summary, the present invention (as embodied herein and as claimed below) is generally directed to an apparatus and method for determining the rotational direction of a rotatable article.

The apparatus preferably comprises an improved balancing system (such as 130) in which imbalance of a rotatable article (such as the spindle motor 106) is measured for subsequent attachment of a balance correction member (such as 122) to correct said imbalance. The balancing system includes an energizing circuit (such as 138) which applies power to rotate the article, an index sensor (such as 134) which detects an index mark (such as 120) on the rotatable article, and a rotational imbalance detection circuit (such as 144) which identifies an appropriate radial position for the balance correction member in relation to the index mark.

The improved balancing system further comprises first means for using the index mark and the index sensor to detect a direction of angular rotation of the article.

In some preferred embodiments, the first means comprises a second sensor (such as 150) positioned adjacent the article at a position a selected circumferential distance from the index sensor other than 180 degrees, wherein the index sensor outputs a first timing pulse when the index mark passes proximate the index sensor, and wherein the second sensor outputs a second timing pulse when the index mark passes proximate the index sensor. The first means further comprises a rotation direction circuit (such as 146) which determines the direction of rotation of the article in relation to the first and second timing pulses.

In alternative preferred embodiments, the first means comprises a second (detection) mark (such as 200, 220) positioned adjacent the article at a position a selected circumferential distance from the index sensor other than 180 degrees, wherein the index sensor outputs a first timing pulse when the index mark passes proximate the index sensor and outputs a second timing pulse when the detection mark passes proximate the index sensor. The first means further comprises a rotation direction circuit (such as 146) which determines the direction of rotation of the article in relation to the first and second timing pulses.

The method preferably comprises steps of providing an index sensor configured to detect an index mark on the rotatable article (such as by step 252); inducing rotation of the article (such as by step 258); using the index sensor and the index mark to determine an angular velocity of the article during said induced rotation, and further using the index sensor and the index mark to determine the angular direction of the article during said induced rotation (such as by steps 260, 262).

For purposes of the appended claims, the structure that carries out the recited function of the “first means” will be understood to comprise the rotational direction detection circuit 146, in conjunction with the second sensor 150 (as set forth by FIGS. 3-6), or in conjunction with the second detection mark 200, 220 (as set forth by FIGS. 7-12). While an optical sensor has been disclosed, other types of sensors including magnetic and hall effect sensors can also be utilized as desired.

It will be clear that the present invention is well adapted to attain the ends and advantages mentioned as well as those inherent therein. While presently preferred embodiments have been described for purposes of this disclosure, numerous changes may be made which will readily suggest themselves to those skilled in the art and which are encompassed in the appended claims.

What is claimed is:

1. In a balancing system of the type in which imbalance of a rotatable article is measured for subsequent attachment of a balance correction member to correct said imbalance, the balancing system including an energizing circuit which applies power to rotate the article, an index sensor which detects an index mark on the rotatable article, and a rotational imbalance detection circuit which identifies an appropriate radial position for the balance correction member in relation to the index mark, the improvement characterized as the balancing system further comprising first means for using the index mark and the index sensor to detect a direction of angular rotation of the article.

2. The improvement of claim 1, wherein the first means comprises:
a second sensor positioned adjacent the article at a position a selected circumferential distance from the index sensor so that a first circumferential distance between the index sensor and the second sensor is less than a second circumferential distance between the index sensor and the second sensor, wherein the index sensor outputs a first timing pulse when the index mark passes proximate the index sensor, and wherein the second sensor outputs a second timing pulse when the index mark passes proximate the index sensor; and
a rotation direction circuit which determines the direction of rotation of the article in relation to the first and second timing pulses.

3. The improvement of claim 2, wherein the rotation direction circuit determines a first elapsed time between an occurrence of the first timing pulse and an occurrence of the second timing pulse, and uses the first elapsed time to detect the rotational direction of the article.

4. The improvement of claim 3, wherein a third timing pulse is generated as the index mark passes the index sensor during a subsequent revolution of the article, wherein the rotation direction circuit further determines a second elapsed time between an occurrence of the second timing pulse and an occurrence of the third timing pulse, and wherein the rotation direction circuit further determines the rotational direction of the article in relation to the first and second elapsed times.

5. The improvement of claim 1, wherein the first means comprises:
a detection mark on the article at a position a selected circumferential distance from the index mark so that a first circumferential distance between the index mark and the detection mark is less than a second circumferential distance between the index mark and the detection mark, wherein the index sensor outputs a first timing pulse when the index mark passes proximate the index sensor and outputs a second timing pulse when the detection mark passes proximate the index sensor; and
a rotation direction circuit which determines the direction of rotation of the article in relation to the first and second timing pulses.

6. The improvement of claim 5, wherein the rotation direction circuit determines a first elapsed time between an occurrence of the first timing pulse and an occurrence of the second timing pulse, and uses the first elapsed time to detect the rotational direction of the article.

7. The improvement of claim 6, wherein a third timing pulse is generated as the index mark passes the index sensor during a subsequent revolution of the article, wherein the rotation direction circuit further determines a second elapsed time between an occurrence of the second timing pulse and an occurrence of the third timing pulse, and wherein the rotation direction circuit further determines the rotational direction of the article in relation to the first and second elapsed times.

8. The improvement of claim 5, wherein the first timing pulse has a first pulse duration, and wherein the second timing pulse has a second pulse duration different than the first pulse duration.

9. The improvement of claim 8, wherein the rotation direction circuit determines the rotational direction of the article in relation to relative magnitudes of the first and second pulse durations.

10. The improvement of claim 1, wherein the rotatable article comprises a spindle motor configured to rotate a data storage medium in a data storage device.

11. In a balancing system of the type in which imbalance of a rotatable article is measured for subsequent attachment of a balance correction member to correct said imbalance, the balancing system including an energizing circuit which applies power to rotate the article, an index sensor which detects an index mark on the rotatable article, and a rotational imbalance detection circuit which identifies an appropriate radial position for the balance correction member in relation to the index mark, a method for detecting angular direction of the article comprising:
using the index mark and the index sensor to detect a direction of angular rotation of the article.

12. The method of claim 11, further comprising:
positioning a second sensor adjacent the article at a position a selected circumferential distance from the index sensor so that a first circumferential distance between the index sensor and the second sensor is less than a second circumferential distance between the index sensor and the second sensor;
utilizing the index sensor to output a first timing pulse as the index mark passes proximate the index sensor;
utilizing the second sensor to output a second timing pulse as the index mark passes proximate the second sensor; and
determining the direction of rotation of the article in relation to relative timing of the first and second timing pulses.

13. The method of claim 12, further comprising utilizing the index sensor to subsequently output a third timing pulse as the index mark subsequently passes proximate the index sensor, measuring a first elapsed time between the first and second timing pulses, and measuring a second elapsed time between the second and third timing pulses.

14. The method of claim 13, wherein the determining step comprises comparing the first elapsed time to the second elapsed time to determine the direction of rotation.

15. The method of claim 11, further comprising:
providing a detection mark on the article at a position a selected circumferential distance from the index mark so that a first circumferential distance between the index mark and the detection mark is less than a second circumferential distance between the index mark and the detection mark;
utilizing the index sensor to output a first timing pulse as the index mark passes proximate the index sensor and to output a second timing pulse as the detection mark passes proximate the index sensor; and
determining the direction of rotation of the article in relation to relative timing of the first and second timing pulses.

16. The method of claim 15, wherein the second timing pulse has a pulse duration that is greater than a pulse duration of the first timing pulse, and wherein the determining step comprises identifying the direction of rotation in relation to the respective durations of the first and second timing pulses.

17. The method of claim 11, wherein the rotatable article is characterized as a spindle motor configured to rotate a data storage medium in a data storage device.

18. A method for detecting an angular direction of a rotating article, comprising:
providing an index sensor configured to detect an index mark on the rotatable article;
inducing rotation of the article;
using the index sensor and the index mark to determine an angular velocity of the article during said induced rotation; and
further using the index sensor and the index mark to determine the angular direction of the article during said induced rotation.

19. The method of claim 19, further comprising:
measuring imbalance in the rotating article; and
identifying an appropriate location for attachment of a balance correction member with respect to the index mark.

20. The method of claim 18, wherein the further using step comprises:
positioning a second sensor adjacent the article at a position a selected circumferential distance from the index sensor so that a first circumferential distance between the index sensor and the second sensor is less than a second circumferential distance between the index sensor and the second sensor;
utilizing the index sensor to output a first timing pulse as the index mark passes proximate the index sensor;
utilizing the second sensor to output a second timing pulse as the index mark passes proximate the second sensor; and
determining the direction of rotation of the article in relation to relative timing of the first and second timing pulses.

21. The method of claim 18, wherein the further using step comprises:
providing a detection mark on the article at a position a selected circumferential distance from the index mark so that a first circumferential distance between the index mark and the detection mark is less than a second circumferential distance between the index mark and the detection mark;
utilizing the index sensor to output a first timing pulse as the index mark passes proximate the index sensor and to output a second timing pulse as the detection mark passes proximate the index sensor; and
determining the direction of rotation of the article in relation to relative timing of the first and second timing pulses.

22. The method of claim 21, wherein the second timing pulse has a pulse duration that is greater than a pulse duration of the first timing pulse, and wherein the determining step comprises identifying the direction of rotation in relation to the respective durations of the first and second timing pulses.

23. The method of claim 18, wherein the rotatable article is characterized as a spindle motor configured to rotate a data storage medium in a data storage device.
